(19) United States
(12) Patent Application Publication
(10) Pub. No.: US 2022/0024661 A1
(43) Pub. Date: Jan. 27, 2022

(54) FLEXIBLE LIDDING FILM

(71) Applicant: Sonoco Development, Inc., Hartsville, SC (US)

(72) Inventor: Donald Gregory Taylor, Hartsville, SC (US)

(21) Appl. No.: 17/497,178

(22) Filed: Oct. 8, 2021

Related U.S. Application Data
(62) Division of application No. 16/694,170, filed on Nov. 25, 2019.

(51) Int. Cl. B65D 65/40; B32B 27/08; B32B 7/12; B32B 27/32; B32B 27/36

(52) U.S. Cl. CPC B65D 65/40; B32B 27/08; B32B 7/12; B32B 2439/46; B32B 27/36; B32B 2307/518; B32B 2435/02; B32B 27/32

(57) ABSTRACT

In an embodiment, the invention is directed to a flexible film comprising an outer polymeric layer, an adhesive layer, a metalized polymeric layer, and a sealant layer adjacent the metalized polymeric layer. The flexible film may also comprise a first polymeric layer, an adhesive layer, a second polymeric layer, a barrier layer, and a sealant layer adjacent the barrier layer.

### CROSS-REFERENCE TO RELATED APPLICATIONS

This application is a Divisional of U.S. patent application Ser. No. 16/694,170 filed Nov. 25, 2019 for FLEXIBLE LIDDING FILM.

### FIELD OF THE INVENTION

The present invention relates generally to flexible lidding film and more particularly for heat-sealable lidding film which tolerates hot and/or humid conditions.

### BACKGROUND

Lidding film often comprises at least one polymer layer, at least one barrier layer adjacent the polymer layer, a layer of biaxially oriented nylon (BON) adjacent the barrier layer, and a sealant adjacent the BON layer. Adhesives may be utilized between the various layers. The sealant side of the lidding film is designed to be heat-sealed to a container. When such multilayer polymeric lidding film is stored for a period of time, particularly prior to application to a container and particularly in hot and/or humid environments (i.e. a warehouse or shipping vehicle), moisture ingress may occur between the sealant and the adjacent BON layer. When the lidding material is then heat sealed onto a container, the heat from the sealing process causes the trapped moisture to “blister” and cause visible air pockets between the sealant and the adjacent BON layer. Upon a visual inspection of the seal area of the lidding film, the air pockets are indistinguishable from what might otherwise be a food contamination issue. An inspection that exposes such a blistering defect results in disposal of the entire packaging structure, due to the high risks associated with food contamination.

### BRIEF SUMMARY

In an embodiment, the invention comprises a lidding film that may be heat sealed to a container and, optionally, then subjected to retort processes. In an embodiment, the lidding film of the invention comprises a barrier material or barrier layer disposed adjacent the sealant layer. The inventive structure, in an embodiment, prevents interlaminar moisture ingress and thereby also prevents interlaminar blistering from occurring.

In an aspect, the invention comprises a flexible film comprising an outer polymeric layer, an adhesive layer, a metalized polymeric layer, and a sealant layer adjacent the metalized polymeric layer. The flexible film may also comprise a first polymeric layer, an adhesive layer, a second polymeric layer, a barrier layer, and a sealant layer adjacent the barrier layer.

In another aspect, the invention comprises a flexible film comprising an outer polymeric layer; an adhesive layer disposed adjacent an inner surface of the outer polymeric layer; a metalized polymeric layer having an outer surface and an inner surface, wherein the outer surface is adhered to the outer polymeric layer via the adhesive layer; and a sealant layer adjacent the inner surface of the metalized polymeric layer.

In still another aspect, the invention comprises a flexible film comprising an outer polymeric layer; a first adhesive layer disposed adjacent an inner surface of the outer polymeric layer; a middle polymeric layer having an inner surface and an outer surface, wherein the outer surface of the middle polymeric layer is adhered to the outer polymeric layer via the first adhesive layer; a second adhesive layer disposed adjacent the inner surface of the middle polymeric layer; a barrier layer having an inner surface and an outer surface, wherein the barrier layer outer surface is adhered to the inner surface of the middle polymeric layer via the second adhesive layer; and a sealant layer adjacent the inner surface of the barrier layer.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates a cross-sectional view of a lidding film of the invention, in an embodiment;

FIG. 2 illustrates a cross-sectional view of a lidding film of the invention, in another embodiment;

FIG. 3 illustrates a cross-sectional view of a lidding film of the invention, in yet another embodiment;

FIG. 4 illustrates a photograph of a top view of a control sample with visible interlaminar blistering;

FIG. 5 illustrates a photograph of a top view of another control sample with visible interlaminar blistering;

FIG. 6 illustrates a photograph of a cross-sectional view of a control sample with visible interlaminar blistering; and

FIG. 7 illustrates a photograph of a top view of an inventive sample with no interlaminar blistering.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As noted, in an embodiment, the invention comprises a lidding film that has a barrier material or barrier layer disposed adjacent the sealant layer. In an embodiment, the lidding film of the invention may comprise at least one layer of polyethylene terephthalate (PET). In a particular embodiment, the lidding film of the invention may comprise a puncture resistant PET. In an embodiment, the inventive film comprises multiple layers of PET.

In an embodiment, the use of a BON layer may be avoided due to the presence of the PET layer(s) and/or the location of the barrier layer. In other embodiments, a BON layer may be utilized, but may not be disposed directly adjacent the sealant. In this embodiment, the BON layer may be located exterior of the barrier layer, opposite the sealant side of the barrier layer. That is, the barrier layer may be disposed between a sealant layer, on the internal side of the lidding film, and a BON layer. The BON layer may be directly adjacent the barrier or may be adhered to the barrier using an adhesive.

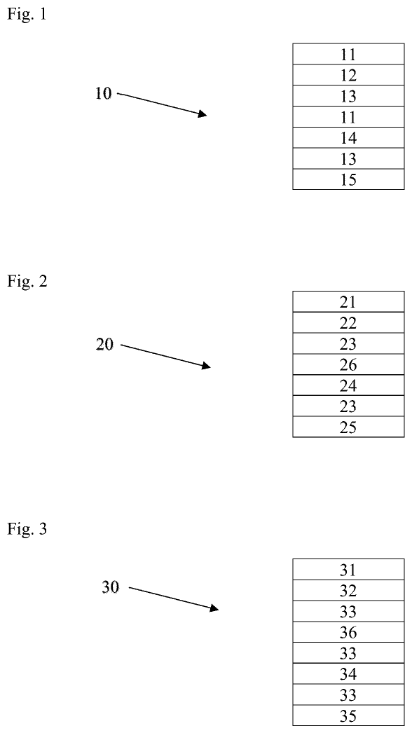

As shown in FIG. 1, in an embodiment, the lidding film 10 may comprise an outer layer 11 which comprises PET and may, in an embodiment, be puncture resistant. While the outer layer 11 is referred to herein as PET, it should be understood that any polymeric film may be utilized. For example, the outer layer 11 may comprise polypropylene (PP), nylon, high density polyethylene, or the like.

Interior of and adjacent to the outer layer 11 may be an optional ink layer 12. The ink layer 12 may be useful in displaying logos, product information, or other branding, colors, or themes for the container. The ink layer 12 may be reverse printed onto the PET outer layer 11, in an embodiment.

An adhesive layer 13 may be disposed adjacent the outer layer 11 and optional ink layer 12. Any adhesive known in the art may be utilized in this or any other embodiment. The adhesives described herein may be permanent adhesives, in some embodiments. The adhesives discussed in various embodiments and in various locations within a particular structural embodiment may be different or may each be the same.

The adhesive layer 13 may adhere the outer PET layer 11 and the optional ink layer 12 to a second PET layer 11, in an embodiment shown in FIG. 1. The second, or inner PET layer 11, may comprise the same form of PET as was utilized in the outer PET layer or may comprise a different form of PET than was used in the outer PET layer.

Again, while the inner PET layer 11 is referred to herein as PET, it should be understood that any polymeric film may be utilized. For example, the inner layer 11 (which could be considered a middle layer) may comprise polypropylene (PP), nylon, high density polyethylene, or the like. The outer polymeric layer 11 and the middle polymeric layer 11 may comprise the same or different polymeric materials.

As shown in FIG. 1, the inner PET layer 11 may be directly adjacent a barrier layer 14. The barrier 14 may be a coating or may be a separate layer. The barrier 14 may comprise any material known in the art that provides a barrier for moisture and/or gases. In some embodiments, the barrier 14 may be a foil material, a metalized film, aluminum oxide coated films, and the like. The barrier 14 may be coextruded with the inner PET layer 11, in an embodiment. Alternatively, the barrier layer 14 may be adhered to the PET layer 11. In other embodiments, the inner polymeric layer 11 may be coated with a barrier material 14. In this and/or any embodiment, the barrier material or layer may face the sealant side of the film lidding.

Interior of the barrier 14, another optional adhesive layer 13 may be utilized. The adhesive 13 may adhere the barrier 14 directly to a sealant material 15. The sealant material may be a heat-sealable material and may comprise any sealant known in the art. The sealant material 15 may be heat-sealable to a container rim, edge, or flange, in an embodiment. The sealant material 15 may be selected for its compatibility with the container to which the lidding is designed to be sealed. In an embodiment, the sealant material may comprise high density polyethylene or cast polypropylene.

In an embodiment, the layers and materials set forth in the inventive lid are coextensive across the entirety of the lidding material. In other embodiments, the sealant 15, for example, may be disposed along the edge of the lidding material, in a location which corresponds to the container rim, edge, or flange to which it is designed to be affixed.

In an embodiment shown in FIG. 2, the inventive structure may mirror that of the FIG. 1 structure, but for the replacement of the internal PET layer 11 with a layer of BON 26. Thus, in this embodiment, the BON layer 26 is disposed between the barrier layer 24 (exterior of the barrier layer) and the outer layer of PET 21 and may be adhered to the PET layer 21 using an adhesive 23. In this embodiment, an optional ink layer 22 may be utilized as set forth with reference to FIG. 1. In this embodiment, the structure 20 may not utilize an adhesive between the BON layer 26 and the barrier layer 24.

Likewise, in an embodiment illustrated in FIG. 3, the inventive structure may mirror that of FIG. 2, with the addition of an adhesive 33 disposed between the barrier layer 34 and the BON layer 36. However, this adhesive between the barrier layer 34 and the BON layer 36 is optional. A foil barrier 34 may be utilized in this embodiment.

### Example 1

The inventive lidding was compared to standard retort lids in experimental tests. The inventive lid comprised the following layers, in this order:

PET (outer)

Adhesive

PET

Barrier

Adhesive

Sealant (inner)

Several control lidding samples were utilized, each of which comprised a barrier layer, but wherein the barrier layer was not adjacent the sealant.

A conditioned chamber (100° F., at 90% relative humidity) was utilized to accelerate the interlaminar blistering defect. The control and inventive samples were conditioned for a specified amount of time (twenty-four (24) hours, seven (7) days, and four (4) weeks, respectively). The samples were exposed to heat using a lab heat sealer (450° F., for 1.5 seconds at 40 PSI) to simulate heat-sealing. The samples were then visually inspected and evaluated for the blistering defect.

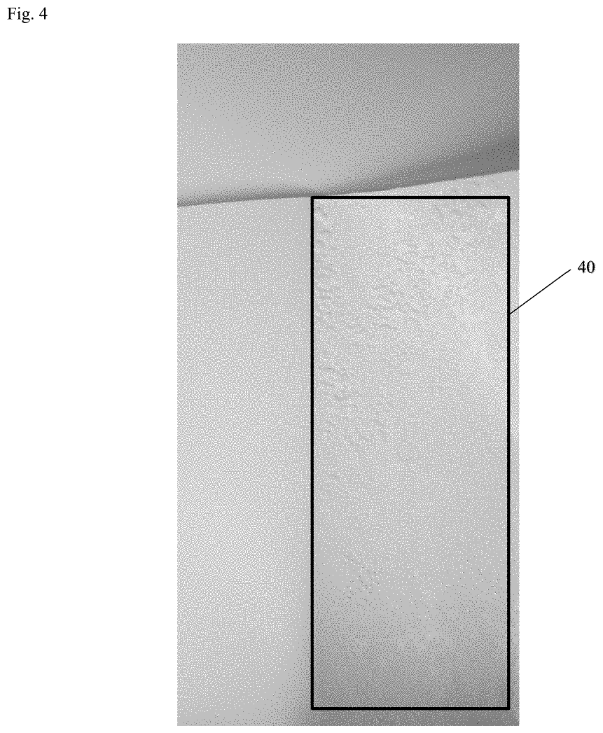

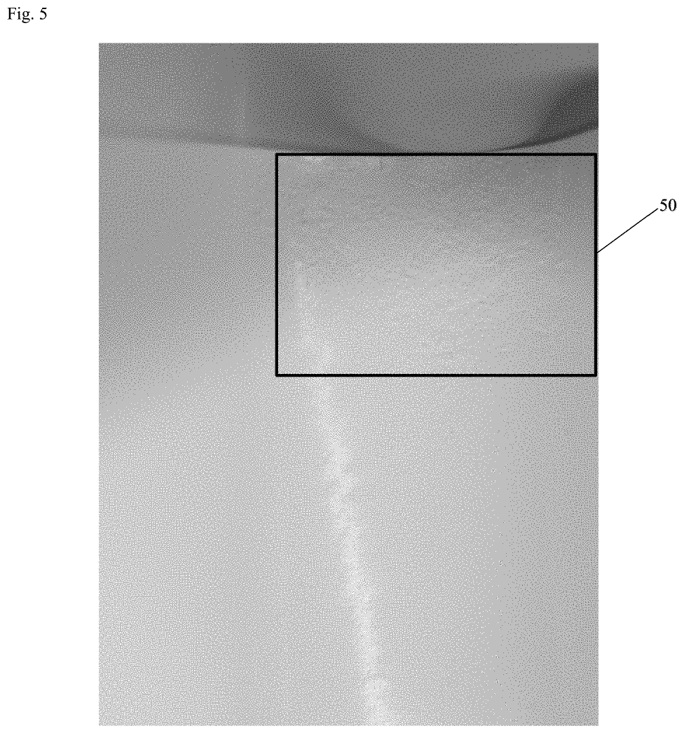

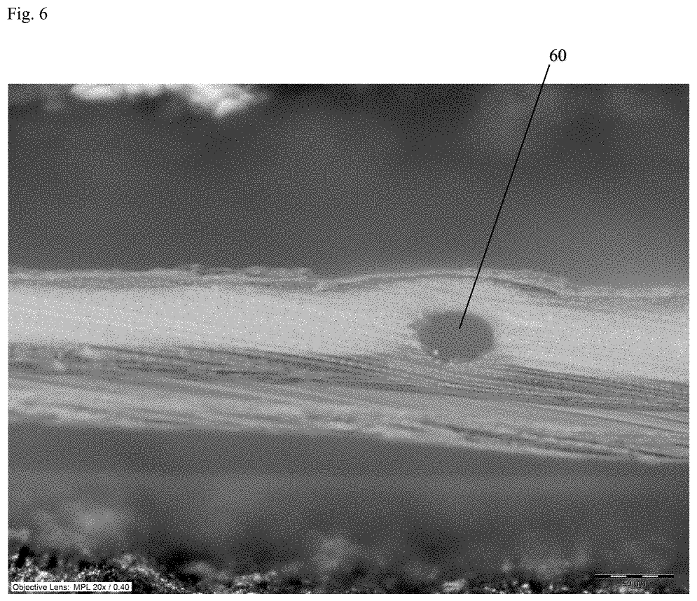

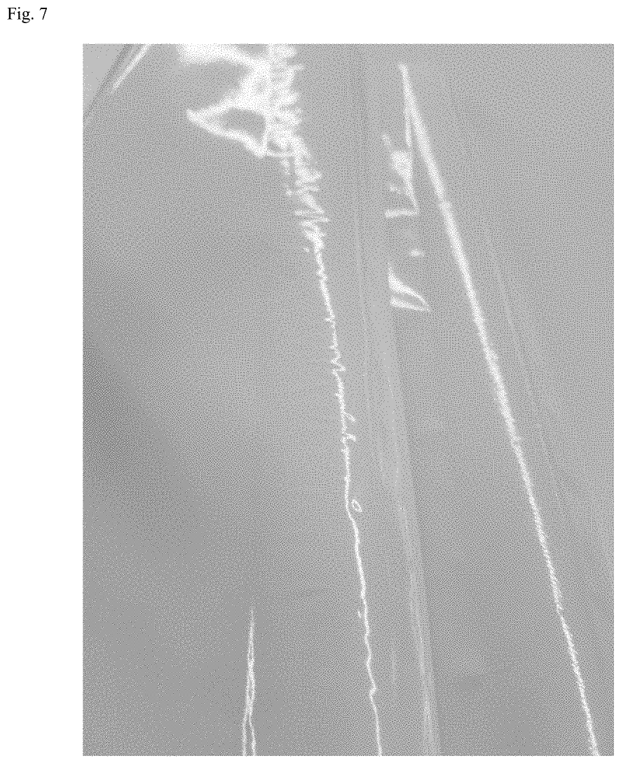

As shown in FIGS. 4-8, the inventive lidding material did not display any interlaminar blistering defects, whereas the control samples were found to have unsatisfactory blistering. FIG. 4 illustrates a top view of a control sample which was subjected to the conditioned chamber for twenty-four (24) hours prior to use of the lab heat sealer. The interlaminar blistering 40 is visible on the top side of the film. FIG. 5 illustrates a top view of a control sample which was subjected to the conditioned chamber for seven (7) days prior to use of the lab heat sealer. The interlaminar blistering 50 is visible on the top side of the film. An exploded cross-sectional view of an interlaminar blister 60 is shown in FIG. 6.

In contrast, FIG. 7 illustrates a top view of an inventive lidding film which was subjected to the conditioned chamber for four (4) weeks prior to use of the lab heat sealer. As can be seen in FIG. 7, there was no interlaminar blistering, visual or otherwise.

Thus, in an embodiment, the invention comprises a method for avoiding interlaminar blistering in retort lidding materials. The method involves forming the lidding material as set forth herein. The inventive lidding material may then be subjected to hot, humid environments and heat sealed to a container without interlaminar blistering defects. In an embodiment, the inventive structure prevents interlaminar moisture ingress.

In an embodiment, the lidding material of the invention comprises a peelable lidding membrane. In an embodiment, the lidding material is sealed to a rigid container. One or more of the layers of the inventive lidding may be co-extruded in certain embodiments. For example, the interior PET layer and the barrier layer may be co-extruded in the embodiment set forth in FIG. 1. Likewise, the BON layer and the barrier layer may be co-extruded in the embodiment set forth in FIG. 2.

While the inventive film is described herein as a lidding film, it should be understood that the inventive film may be utilized for any flexible film needs known in the art. The inventive film may be particularly useful in applications where the film material is subjected to hot, humid conditions prior to being sealed. For example, the invention may be useful for a flexible film pouch or bag which is transported to a customer location prior to being filled and heat-sealed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of forming a blister resistant laminate, the method comprising:
joining a layer of biaxially oriented nylon to a barrier material;
applying a first adhesive to the barrier material;
applying a sealant material to the first adhesive; and
applying a polymeric layer to the biaxially oriented nylon layer via a second adhesive to form a laminate, wherein the laminate is blister resistant.

2. The method of claim 1, wherein the joined layer is formed by coextrusion.

3. The method of claim 1, wherein joining the biaxially oriented nylon layer and the barrier material further comprises:
applying an adhesive to one of either the layer of biaxially oriented nylon and the barrier material.

4. The method of claim 1, wherein joining the layer of biaxially oriented nylon layer and the barrier material comprises:
coating the biaxially oriented nylon layer with the barrier material.

5. The method of claim 1, further comprising reverse printing an ink layer onto the polymeric layer.

6. The method of claim 1, wherein the polymeric layer is a puncture resistant polyethylene terephthalate.

7. The method of claim 1, wherein the first adhesive is a permanent adhesive.

8. The method of claim 1, wherein the barrier material comprises a moisture barrier.

9. The method of claim 1, further comprising storing the laminate at up to 100° F. and up to 90% relative humidity for a period of time; and
heat sealing the laminate.

10. The method of claim 9, wherein the period of time is up to four weeks.

11. The method of claim 9, wherein the temperature is maintained at approximately 100° F. and approximately 90% relative humidity.

12. The method of claim 9, wherein the heat sealing comprises exposure to a heat of approximately 450° F. for approximately 1.5 seconds at approximately 40 PSI.

13. The method of claim 1 wherein blister resistant comprises no visual interlaminar blistering defects.

14. The method of claim 1, wherein the laminate is blister resistant following retort processing.

15. The method of claim 1, wherein the barrier material is a foil.

16. A method of making a container, the method comprising:
sealing the blister resistant laminate of claim 1 onto a rigid container.

17. A blister resistant laminate formed by the process of
joining a layer of biaxially oriented nylon to a barrier material;
applying a first adhesive to the barrier material;
applying a sealant material to the first adhesive; and
applying a polymeric layer to the biaxially oriented nylon layer via a second adhesive to form a laminate, wherein the laminate is blister resistant after an extended exposure to a hot humid environment before exposure to a heat seal.
